(19) United States
(12) Patent Application Publication
(10) Pub. No.: US 2012/0273311 A1
(43) Pub. Date: Nov. 1, 2012

(54) ADJUSTABLE DAMPING VALVE DEVICE FOR A VIBRATION DAMPER

(75) Inventor: Hubert Beck, Eitorf (DE)

(73) Assignee: ZF Friedrichshafen AG, Friedrichshafen (DE)

(21) Appl. No.: 13/432,720

(22) Filed: Mar. 28, 2012

(30) Foreign Application Priority Data
Mar. 28, 2011 (DE) 10 2011 006 204.1
May 16, 2011 (DE) 10 2011 075 909.3

(51) Int. Cl. F16F 9/34

(52) U.S. Cl. 188/322.15

(57) ABSTRACT

Damping valve device for a vibration damper, including an actuator that acts on a preliminary stage valve body of a preliminary stage valve. The preliminary stage valve body is arranged in a pre-loading line with a main stage valve body of a main stage valve. The lifting path of the main stage valve body is proportional to the lifting path of the preliminary stage valve body, and the damping characteristic of the damping valve device is influenced by a valve spring arrangement. The preliminary stage valve body controls an adjustable spring compressor that determines the pre-loading of a main stage valve spring is part of the valve spring arrangement.

### BACKGROUND OF THE INVENTION

1. Field of the Invention

The invention is directed to a damping valve device for a vibration damper.

2. Description of the Related Art

DE 198 22 448 A1 is directed to a generic damping valve device having a preliminary stage valve body actuated by an electric actuator that acts directly on a flow-off channel of a main stage valve body. The preliminary stage valve body is pre-loaded in direction of the main stage valve body by a valve spring arrangement. The main stage valve body is repositioned as the preliminary stage valve body carries out an axial adjusting movement. Therefore, this type of valve construction is also known as a path follower valve. The force of the valve spring arrangement and the hydraulic closing force in a control space act in parallel on the main stage valve body. This results in design guidelines for the constructional shape and dimensioning of the main stage valve body.

### SUMMARY OF THE INVENTION

An object of the present invention is an alternative damping valve device constructed in a simple manner that allows damping force characteristics to meet the demands of the vehicle.

According to one embodiment of the invention, a preliminary stage valve body controls an adjustable spring compressor that determines the pre-loading of a main stage valve spring as a component part of the valve spring arrangement.

An advantage of this construction principle consists in that a force-path-follower valve is now made available. The operating path of the preliminary stage valve body is not necessarily identical to the operating path of the main stage valve body. The main stage valve body realizes a longer or shorter operating path depending on the adjusted pre-loading of the main stage valve spring.

In one embodiment of the invention, the spring compressor is movably guided in a valve housing, and a back side of the spring compressor, remote of the main stage valve spring, and a base of the valve housing form a control space filled with damping medium. The dimensioning of the back side of the spring compressor is not dependent upon the dimensioning of the opening surface at the main stage valve body. This independence of the surfaces to which pressure is applied by the damping medium allows a very large range with respect to adapting the damping valve to a desired damping force characteristic. Accordingly, the surface at the spring compressor to which pressure is applied can also be larger than a surface at the main stage valve to which pressure is applied in the opening direction so that particularly high damping forces can also be achieved.

The spring compressor has a flow-off channel proceeding from the control space; the flow-off cross section of the flow-off channel is controlled by the preliminary stage valve body. Therefore, the geometry of the main stage valve body can be simplified compared to the prior art.

According to one embodiment, the preliminary stage valve body is pre-loaded by an adjusting spring as part of the valve spring arrangement for purposes of path adjustment. The entire preliminary stage valve can be checked independently from the main stage valve before installing in the damping valve device. The actuator and the adjusting spring can be adapted to one another in an exact manner.

To prevent an instantaneous response of the main stage valve under all circumstances, a lift space axially limited by the spring compressor and main stage valve body is connected to a flow-off space of the damping valve device. The connection to the flow-off space leads to a compensation of the damping medium displaced due to the operating movement of the main stage valve body.

For purposes of a compact construction of the main stage valve, the main stage valve spring is arranged in the lift space. It is advantageously provided that the main stage valve spring is formed by at least one disk spring.

According to one embodiment, the spring compressor has a guide portion for the circular ring-shaped main stage valve body. The main stage valve body cannot carry out a tilting movement even with a comparatively short guide length.

A particularly short damping valve device which is also constructed in a simple manner is characterized in that the at least one disk spring is pre-loaded between the spring compressor and the main stage valve seat surface and therefore forms the main stage valve body.

In one embodiment, the main stage valve has a first and a second main stage valve seat surface; the at least one disk spring contacts a main stage valve seat surface, and the spring compressor rests on the other main stage valve seat surface; and the second main stage valve seat surface is formed by a valve seat sleeve at which the at least one disk spring is supported. This constructional form does away with the dependency between the disk spring and the valve seat surface with respect to size. Depending on the radial extension of the valve seat sleeve, a narrower or wider disk spring can be used, e.g., with identical valve seat diameter.

It can also be provided that at least two disk springs are used in a series arrangement, wherein one disk spring is connected in parallel with at least one bypass aperture. An opening force which is dependent upon flow direction is achieved for the at least two disk springs. The bypass aperture can be constructed in the disk spring or in the structural component part supporting the disk spring.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described more fully with reference to the following description of the drawings. The drawings show:

FIGS. 1 and 2 are a damping valve device in different positions of a preliminary stage valve; and

FIGS. 3 and 4 are a damping valve device having at least one disk spring as main stage valve body.

### DETAILED DESCRIPTION OF THE PRESENTLY PREFERRED EMBODIMENTS

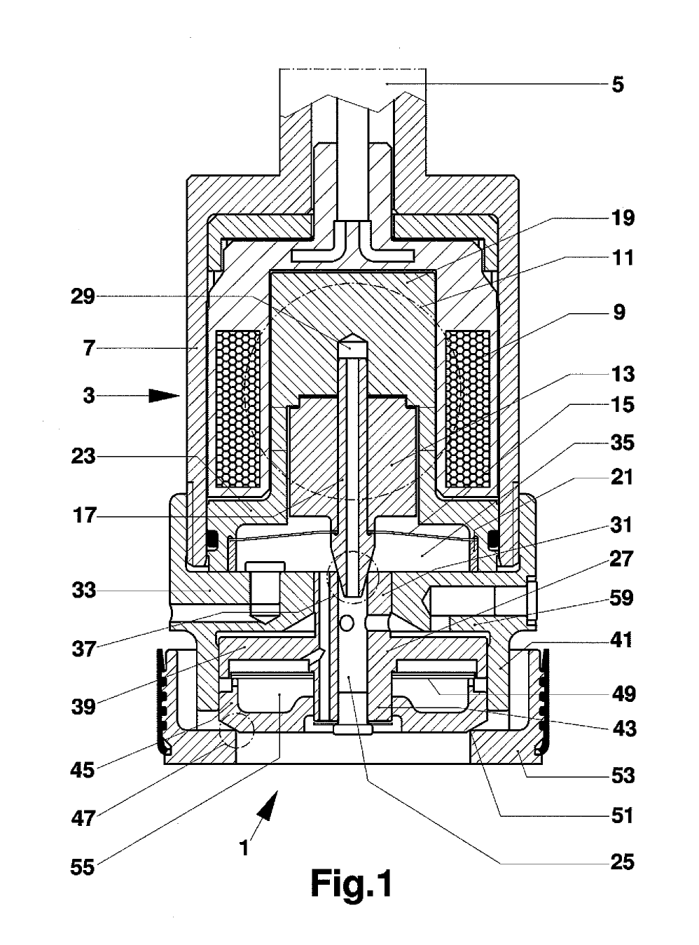

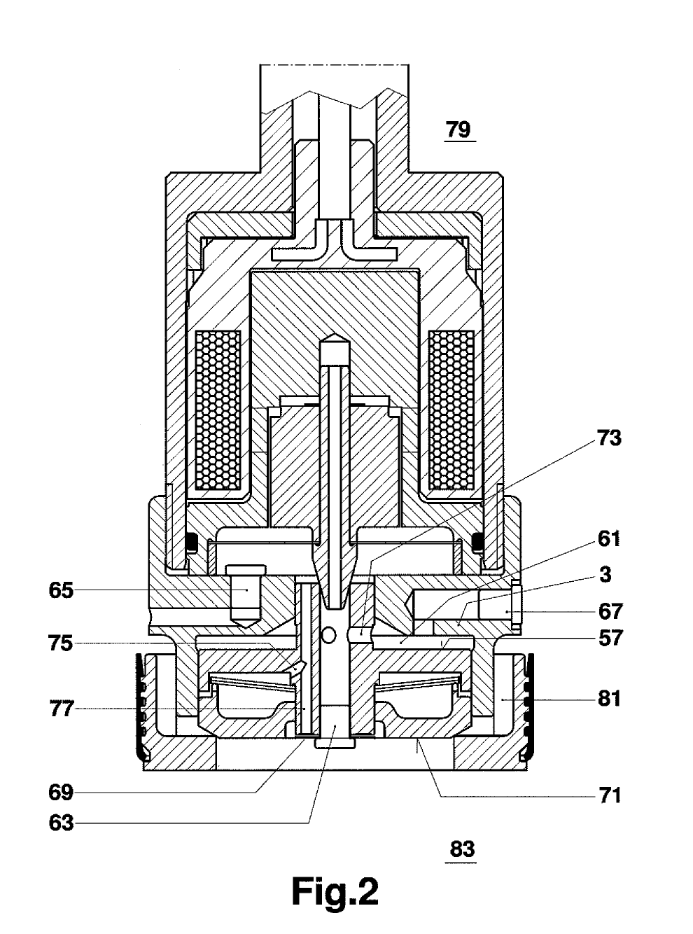

FIGS. 1 and 2 show a first embodiment form of a damping valve device 1 fastened in a valve housing 3 to a piston rod 5 of a vibration damper, only a section of which is shown. In principle, however, the invention is not limited to this arrangement in the vibration damper. A coil 9 is arranged as part of an actuator in a sleeve-shaped valve housing part 7. In principle, the actuator can be constructed in any manner, i.e., as an electric, pneumatic, hydraulic or mechanical actuator. The coil 9 exerts a magnetic force on a preliminary stage valve body 13 acted upon by a disk-shaped adjusting spring 15. The preliminary stage valve body 13 has a tubular axle member 17 supported by a first end in a disk-shaped enclosing sleeve element 19. A clamping ring 21 fixes the adjusting spring 15 to a dividing wall 23 of the valve housing. The dividing wall 23 is in turn clamped inside the valve housing 3.

The preliminary stage valve body 13 is supported by the other end in a flow-off channel 25 of a spring compressor 27 by its tubular axle member 17. The flow-off channel 25 has the same cross section as the pocket bore hole 29 in the enclosing sleeve element 19. The spring compressor 27 comprises a pin-shaped guide portion 31 that is guided in an intermediate housing portion 33. With the dividing wall 23, the intermediate housing portion 33 forms a flow-off space 35 of a preliminary stage valve 37. A flange area 39 guided in an annular wall 41 of the intermediate housing portion 33 so as to be movable axially adjoins the guide portion 31. A circular ring-shaped main stage valve body 45 of a main stage valve 47 is supported on a second guide portion 43 of the spring compressor 27 so as to be axially displaceable. The main stage valve body 45 is pre-loaded by a main stage valve spring 49 in the construction of at least one disk spring on a main stage valve seat surface 51. Although a disk spring is shown, other types of construction are also usable in principle. The main stage valve seat surface 51 is in turn formed at a valve seat ring 53 which is fixed to the valve housing 3.

The main stage valve body 45 and the flange area 39 of the spring compressor 27 define a lift space 55 in which the main stage valve spring 49 is arranged. This lift space 55 adjoins the flow-off space 35 of the preliminary stage valve 37.

A back side 57 of the spring compressor 27 at the flange area 39, which back side 57 is remote of the main stage valve spring 49, and a base 59 of the valve housing 3 form a control space 61 filled with damping medium. The control space 61 is connected to the flow-off space 35 by the flow-off channel 25; the flow-off cross section of the flow-off channel 25 is controlled by the preliminary stage valve body 13.

A check valve arrangement 63, 65, 67, and 69 ensures a uniform direction of a pilot damping medium flow into the control space 61 and, therefore, into the flow-off channel 25 irrespective of the incident flow direction of the main stage valve body 45. With an incident flow of the main stage valve body 45 via a front side 71 of the main stage valve body 45, check valves 63 and 65 are opened in the through direction and check valves 67 and 69 are closed. The damping medium flows into the flow-off channel 25 in direction of the preliminary stage valve 33. Damping medium flows into the control space 61 via at least one radial aperture in the spring compressor 27 and impinges on the back side 57 of the spring compressor 27. Damping medium is prevented from flowing out of the control space by the closed check valve 67. Damping medium arrives in the pocket hole 29 of the disk body 19 via the tubular axle member 17. Accordingly, the preliminary stage valve body is hydraulically loaded in a balanced manner. The force acting on the spring compressor 27 results from the basic pre-loading of the adjusting spring 15 and the oppositely directed magnetic force of the actuator 11. A flow-off cross section occurring at the preliminary stage valve 37 is proportional to a throttle cross section of the opened check valve 63 in direction of the flow-off channel 25. Accordingly, the spring compressor 27 always follows the respective position setting of the actuator and preliminary stage valve body 13. Consequently, the pre-loading of the main stage valve spring changes. In FIG. 1, there is a maximum energizing of the coil 9; therefore, the adjusting spring 15 is shielded to a maximum degree. Consequently, the main stage valve spring 49 is only slightly pre-loaded. The incident flow of the main stage valve 45 then tends towards a low damping force. FIG. 2 shows how the position of the preliminary stage valve body 13 displaces in direction of the spring compressor 27 due to a greater change in the resulting actuating force of the actuator by the weaker energizing. The spring compressor 27 moves in direction of the main stage valve body 45 and accordingly pre-loads the main stage valve spring 49 to a greater extent. With a higher pre-loading of the main stage valve spring 49, there is a tendency to need greater force to lift the main stage valve body 45 from the valve seat surface 51. The damping force setting is harder. During an adjusting movement of the preliminary stage valve body 13 or a lifting movement of the main stage valve body 45, an axial relative movement takes place between the main stage valve body 45 and the spring compressor 27 in the area of the second guide portion 43. During every relative movement, the lift space 55 can discharge damping medium to the flow-off space 35 or receive damping medium from the latter via a connection port 75 and a connection channel 77 to which check valve 69 is also connected.

When flow impinges on the main stage valve body 45 radially via the valve seat ring 53 and radial channels 81, e.g., from a work space 79 on the piston rod side filled with damping medium, check valves 67 and 69 are opened and check valves 63 and 65 are closed. Damping medium can in turn flow into the control space 61 and can flow further into the flow-off channel 25. Depending on the resulting actuating force of the actuator or energizing of the coil 9 and the resulting pressure level in the control space 61, the spring compressor 27 displaces and pre-loads the main stage valve spring 49 to a greater or lesser extent. The damping medium flowing out of the flow-off channel 25 into the flow-off space 35 can flow out of the damping valve device 1 via the connection channel 77 and the opened check valve 69, in this case into a work space 83 remote of the piston rod.

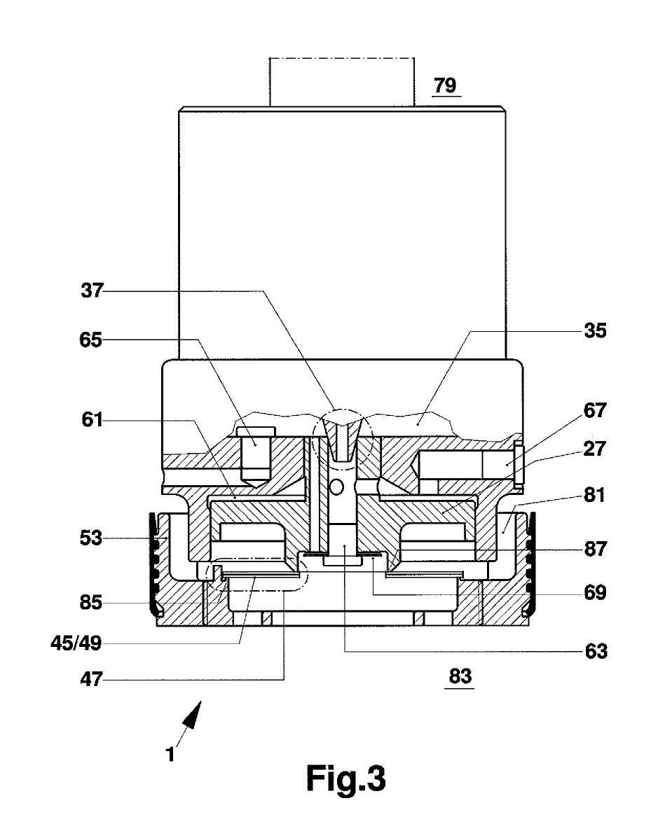

The variant according to FIG. 3 is identical to the construction according to FIGS. 1 to 3 with regard to the entire preliminary stage valve 37 and the configuration of the check valve arrangement 63, 65, 67, and 69. In contrast, the main stage valve spring 49, which is likewise constructed as a disk spring, also forms the main stage valve body 45. The main stage valve 47 has a first main stage valve seat surface 85 at the valve seat ring 53 and a second main stage valve seat surface 87 at the spring compressor 27. The at least one disk spring 49 is pre-loaded between these two valve seat surfaces 85 and 87. The disk spring 49 can lift from the valve seat surface 85 of the valve seat ring 53 at the outer circumference when there is an incident flow from the work space 83 remote of the piston rod and at the inner diameter or at the valve seat surface 87 when there is incident flow via the at least one radial aperture 81.

When damping medium flows in via the radial aperture 81 with the same volume flow and setting of the actuator 11, there is a larger damping force; the throughflow cross section at the inner diameter of the disk spring is smaller that at the outer diameter.

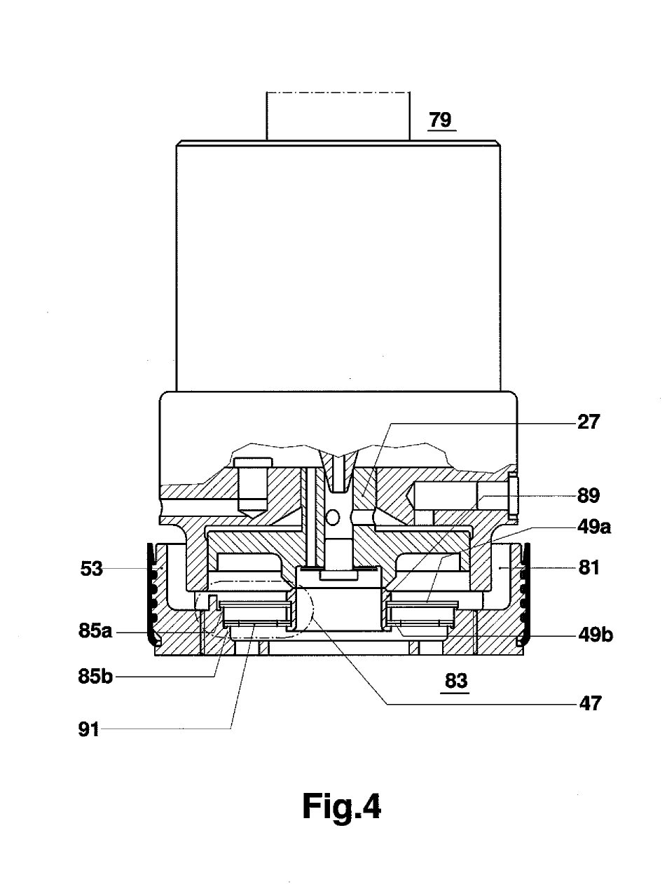

In FIG. 4, based on the damping valve device according to FIG. 4, the difference in damping force between the two impingement directions is still greater. To this end, at least two disk springs 49a and 49b are used which are supported, respectively, by their outer diameter at a first main stage valve seat surface 85a and 85b, respectively, of the valve seat ring 53. The two disk springs 49a and 49b are pre-loaded on a valve seat sleeve 89 by their inner diameters. An end face of the valve seat sleeve 89 forms a second main stage valve seat surface 87 on which the spring compressor 27 is supported.

With incident flow proceeding from the work space 87 remote of the piston rod, the damping medium can flow via at least one bypass aperture 91 in the disk spring 49b, which is accordingly functionally connected in parallel with the disk spring 49b, to the second disk spring 49a without the first disk spring 49b lifting from its valve seat surface 85b. In connection with the relatively large through cross section at the outer diameter of the disk spring 49a, a larger damping medium volume flow can flow through the main stage valve 47.

On the other hand, if the damping medium is supplied via the at least one radial aperture 81, there must be an opening force which is greater than the closing forces of the two disk springs 49a; 49b which now act in concert. When there is an opening movement, the valve seat sleeve 89 lifts from the spring compressor 27 so that the damping medium can flow into the work space 83 remote of the piston rod.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A damping valve device for a vibration damper, comprising:
a preliminary stage valve body of a preliminary stage valve;
an actuator that acts on the preliminary stage valve body of the preliminary stage valve;
a main stage valve body of a main stage valve, wherein the preliminary stage valve body is arranged in a pre-loading line with the main stage valve body; and
a valve spring arrangement configured to influence a damping characteristic of the damping valve device; and
an adjustable spring compressor controlled by the preliminary stage valve body that determines a pre-loading of a main stage valve spring as component part of the valve spring arrangement,
wherein a lifting path of the main stage valve body is proportional to a lifting path of the preliminary stage valve body.

2. The damping valve device according to claim 1, wherein the adjustable spring compressor is movably guided in a valve housing, wherein a back side of the spring compressor remote of the main stage valve spring and a base of the valve housing form a control space that is filled with damping medium.

3. The damping valve device according to claim 2, wherein the adjustable spring compressor comprises a flow-off channel proceeding from the control space, wherein a flow-off cross section of the flow-off channel is controlled by the preliminary stage valve body.

4. The damping valve device according to claim 1, further comprising an adjusting spring configured to preload the preliminary stage valve body.

5. The damping valve device according to claim 1, wherein a lift space that is axially limited by the adjustable spring compressor and the main stage valve body is connected to a flow-off space of the damping valve device.

6. The damping valve device according to claim 5, wherein the main stage valve spring is arranged in the lift space.

7. The damping valve device according to claim 1, wherein the main stage valve spring is formed by at least one disk spring.

8. The damping valve device according to claim 1, wherein the adjustable spring compressor comprises a guide portion for the main stage valve body, wherein the main stage valve body is a circular ring-shape.

9. The damping valve device according to claim 7, wherein the main stage valve body comprises the at least one disk spring pre-loaded between the adjustable spring compressor and a main stage valve seat surface.

10. The damping valve device according to claim 9, wherein the main stage valve has a first and a second main stage valve seat surface, wherein the at least one disk spring contacts the main stage valve seat surface, and the adjustable spring compressor rests on an other main stage valve seat surface, wherein a second main stage valve seat surface is a valve seat sleeve at which the at least one disk spring is supported.

11. The damping valve device according to claim 10, wherein at least two disk springs are used in a series arrangement, wherein a first disk spring is connected in parallel with at least one bypass aperture.

12. The damping valve device according to claim 6, wherein the main stage valve spring is formed by at least one disk spring.
